(19) United States
(12) Patent Application Publication
(10) Pub. No.: US 2021/0380788 A1
(43) Pub. Date: Dec. 9, 2021

(54) COMPOSITIONS OF POLYMER PROCESSING ADDITIVES AND PRODUCTS MADE USING SUCH COMPOSITIONS

(71) Applicant: 3M INNOVATIVE PROPERTIES COMPANY, St. Paul, MN (US)

(72) Inventor: Roman I. Vasiliev, Kazan, Pavlukhina (RU)

(21) Appl. No.: 17/297,288

(22) PCT Filed: Nov. 22, 2019
(86) PCT No.: PCT/IB2019/060090

§ 371 Date: May 26, 2021

(30) Foreign Application Priority Data
Nov. 27, 2018 (RU) 2018141773

(51) Int. Cl. C08L 23/12

(52) U.S. Cl. CPC C08L 23/12; C08L 2207/04; C08L 2205/035; C08L 2205/06

(57) ABSTRACT

A polymer processing additive (PPA) composition to improve melt extrusion of an extruded composition comprising an extruded thermoplastic polymer, the PPA composition comprising of at least one fluoropolymer having a Mooney viscosity (ML 1+10 @ 121° C.) of about 30 to about 90 (ASTM D 1646-06 Part A with an MV 2000 instrument (available from Alpha Technologies, Ohio) using a large rotor (ML 1+10) at 121° C.) and at least one polydiorganosiloxane polymer, wherein said extruded thermoplastic polymer is selected from a polypropylene homopolymer, a polypropylene copolymer, and a combination thereof. Also provided is a method for extruding polymers using the PPA compositions, as well as extruded products comprising the PPA composition.

### FIELD OF THE INVENTION

The invention relates to compositions of polymer technological (processing) additives comprising at least one organosilicon polymer and at least one fluoropolymer. The composition of polymer processing additives (PPA) may be utilized for melt processing of thermoplastic polymers. The invention also relates to products manufactured via melt processing and made using such PPA, as well as to the manufacturing methods of such products.

### BACKGROUND OF THE INVENTION

Extrusion of polymer materials to obtain and form products is a large segment of the plastic and polymer product industry. Any composition of a melt-processed thermoplastic polymer has its critical shear rate, above which the extrudate surface becomes uneven or deformed and below which the extrudate is smooth. The quality of the extruded product and the overall success of the extrusion process usually depend on the interaction of the fluent material with the extrusion die. It is generally believed that a polymer deposits on the extrusion die when the shear rate exceeds a certain value. Polymer deposition on the extrusion die can lead not only to surface defects, but also to other problems. Those include polymer buildup at the die aperture (also known as material accumulation at the extrusion die, or sags at the extrusion die) and increased backpressure during extrusion. These problems slow down the extrusion process, as the process either has to be interrupted to clean the equipment, or has to be performed at a lower rate.

Additives for polymer processing, also referred to as “polymer processing additives”, or “PPA”, have been utilized to alleviate or overcome such problems. PPA can reduce melt accumulation at the die and can increase the shear rates at which thermoplastic polymers may be extruded without visible melt defects. Fluoropolymers are also used as a polymer processing additive, as disclosed, e.g., in U.S. Pat. Nos. 5,015,693 and 4,855,013 (Duchesne et al.), U.S. Pat. No. 5,701,217 (Blong et al.), and U.S. Pat. No. 6,277,919 (Dillon et al.). U.S. Pat. No. 5,015,693 (Duchesne et al.) describes how under certain conditions, a combination of a fluoropolymer and a poly(oxyalkylene) polymer is more efficient than the fluoropolymer alone in the reduction of melt defects. U.S. Pat. No. 6,294,604 (Focquet et al.) describes a combination of a fluoropolymer, a poly(oxyalkylene) polymer, and magnesium oxide as an extrusion additive. Furthermore, various organosilicon compounds have been reported as possible polymer processing additives to reduce melt defects (i.e., U.S. Pat. No. 4,535,113 (Foster et al.)). International patent application WO 2015/042415 describes a way to improve the properties of polymer processing additives comprising fluoropolymers or organosilicon polymers by introducing synergistic additives, such as combinations of poly(oxyalkylene) polymers and the salts of certain organic acids. U.S. Pat. No. 4,740,341 describes how a combination of certain fluoropolymers with siloxane polymers may improve the extrusion of polyethylene.

There remains an ongoing need for alternative compositions of polymer processing additives. Such compositions will, desirably, be efficient in the processing of polymers with poor melt shear properties in general, and of polypropylene-based polymers in particular.

### SUMMARY OF THE INVENTION

The inventors have found that compositions of polymer processing additives comprising a combination of at least one fluoropolymer and at least one organosilicon polymer are exceptionally efficient as polymer processing additives for melt-processed extruded polymers. Thus, in one aspect, the invention provides a polymer processing additive (PPA) composition to improve melt extrusion of an extruded composition comprising an extruded thermoplastic polymer, wherein the PPA composition contains at least one fluoropolymer having a Mooney viscosity (ML 1+10 @ 121° C.) of about 30 to about 90 (ASTM D 1646-06 Part A), and at least one polydiorganosiloxane polymer, wherein the extruded thermoplastic polymer is selected from a polypropylene homopolymer, a polypropylene copolymer, and a combination thereof.

In another aspect, the invention provides an extruded composition comprising about 0.002 to 50 weight percent (relative to the total weight of the composition, constituting 100 weight percent) of the composition of the polymer processing additive of the invention, and at least 50 weight percent (relative to the total weight of the composition, constituting 100 weight percent) of an extruded thermoplastic polymer selected from polypropylene homopolymers, polypropylene copolymers, and combinations thereof.

In yet another aspect, the invention provides an extruded product comprising the extruded composition.

In another aspect still, the invention provides a method for making a melt extruded product, involving extrusion of an extruded composition comprising an extruded thermoplastic polymer and further comprising a polymer processing additive composition, wherein said extruded thermoplastic polymer is selected from polypropylene homopolymers, polypropylene copolymers, and combinations thereof.

Various aspects and advantages of the embodiments of the invention have been summarized above. The above summary is not intended to cover every illustrative embodiment or every practical implementation of the invention.

### DETAILED DESCRIPTION OF THE INVENTION

Throughout this disclosure:

The singular forms “a”, “an”, and “the” do not refer only to a single object, but include the general class, a specific example of which may be used for illustrative purposes. Any terms referring to a singular object are used interchangeably with the term “at least one”.

As used herein, the term “comprising at least one of”, followed by a list, refers to that comprising any of the listed items and any combination of two or more of the listed items. As used herein, the term “at least one of”, followed by a list, refers to any of the listed items or to any combination of two or more of the listed items.

As used herein, the term “perfluoroalkyl group” includes linear, branched, and/or cyclic alkyl groups in which all C—H bonds have been replaced by C—F bonds.

As used herein, the term “with at least one intervening functional group”, e.g., referring to an alkyl, an alkylene, or an arylalkylene, refers to such alkyl, alkylene, or arylalkylene having its portions on both sides of the functional group. An example of alkylene with an intervening —O— group is —CH₂—CH₂—O—CH₂—CH₂—.

As used herein, the name “polypropylene” is the original name of “polypropene”. Both names are used interchangeably throughout this disclosure. The same also applies to “polyethylene” and “polyethene”; “propylene” and “propene”; and “ethylene” and “ethene”.

The terms “weight percent”, “percent by weight”, “weight %”, and “wt %” are used interchangeably.

Unless otherwise stated, where a range of numerical values is recited herein, the range includes the endpoints thereof and noninteger values therebetween.

As used herein, the “Mooney Viscosity Procedure” is the method of determining the Mooney viscosity according to ASTM D 1646-06 Part A (in effect on Jan. 1, 2019) with an MV 2000 instrument (available from Alpha Technologies, Ohio) using a large rotor (ML 1+10) at 121° C.

Fluoropolymers

Fluoropolymers suitable for the compositions of polymer processing additives in accordance with the invention include fluoropolymers with a Mooney viscosity (ML 1+10 @ 121° C.) in the range of 30 to 150, as measured according to the Mooney Viscosity Procedure. Examples of these include, but are not limited to, fluoropolymers with a Mooney viscosity in the range of 30 to 120, 30 to 110, or 30 to 90. In some embodiments, the Mooney viscosity ML 1+10 @ 121° C. of the fluoropolymer is in the range of about 35 to about 82. In some embodiments, the Mooney viscosity ML 1+10 @ 121° C. of the fluoropolymer is in the range of about 30 to less than 60, e.g.: 59, 58, 55, or 50. In some embodiments, the Mooney viscosity ML 1+10 @ 121° C. of the fluoropolymer is in the range of about 40 to about 58, about 40 to about 55, or about 43 to about 53. In some embodiments, the Mooney viscosity ML 1+10 @ 121° C. of the fluoropolymer is in the range of about 60 to about 90, about 60 to about 80, or about 65 to about 75. The Mooney viscosity may be adjusted, e.g., by controlling the molecular weight and degree of branching of the fluoropolymer. Such polymers usually comprise elastomeric fluoropolymers. Such fluoropolymers usually have their glass transition point below room temperature and are usually amorphous.

Fluoropolymers suitable as polymer processing additives in the PPA compositions of the invention include copolymers of vinylidene fluoride (VDF) and hexafluoropropylene (HFP). In some embodiments, the polymers may have a fluorine to carbon ratio of at least 1:2, in some embodiments, of at least 1:1; and/or the fluorine to hydrogen ratio of at least 1:1.5.

The VDF-HFP copolymers may optionally include units derived from one or more additional comonomers. Examples of such additional comonomers include at least one partially fluorinated or at least one perfluorinated monomer with an ethylenic double bond of formula R^{a}CF═CR^{a}₂, where each R^{a} is independently fluoro, chloro, bromo, hydrogen, fluoroalkyl (e.g., a perfluoroalkyl comprising 1 to 8, 1 to 4, or 1 to 3 carbon atoms, optionally with one or more intervening oxygen atoms), fluoroalkoxy (e.g., a perfluoroalkoxy comprising 1 to 8, 1 to 4, or 1 to 3 carbon atoms, optionally with one or more intervening oxygen atoms), alkyl or alkoxyl comprising 1 to 8 carbon atoms, aryl comprising 1 to 8 carbon atoms, or a cyclic saturated alkyl comprising 1 to 10 carbon atoms. Examples of suitable fluorinated monomers of formula R^{a}CF═CR^{a}₂ include tetrafluoroethylene (TFE), chlorotrifluoroethylene, 2-chloropentafluoropropylene, dichlorodifluoroethylene, 1,1-dichlorofluoroethylene, 1-hydropentafluoropropylene, 2-hydropentafluoropropylene, 3,3,3-trifluoropropylene, perfluorinated vinyl ethers, perfluorinated allyl ethers, and mixtures thereof. Examples of perfluorinated vinyl ethers and perfluorinated allyl ethers are represented by formula CF₂═CF—(CF₂)ₙ—ORf, where n is 0 for a vinyl ether and n is 1 for an allyl ether. Rf is a perfluoroalkyl comprising 1 to 8, 1 to 4, or 1 to 3 carbon atoms, optionally with one or more intervening —O— groups. Perfluoroalkoxyalkylvinyl ethers suitable for obtaining the amorphous fluoropolymer include compounds of formula CF₂═CF(OCₙF₂ₙ)_{z}ORf₂, where each n is independently 1 to 6, z is 1 or 2, and Rf₂ is a linear or branched perfluoroalkyl comprising 1 to 8 carbon atoms, optionally with one or more intervening —O— groups. In some embodiments, n is 1 to 4, or 1 to 3, or 2 to 3, or 2 to 4. In some embodiments, n is 3. CₙF₂ₙ may be either linear or branched. In some embodiments, CₙF₂ₙ may be written as (CF₂)ₙ and may refer to a linear perfluoroalkylene. In some embodiments, CₙF₂ₙ is —CF₂—CF₂—CF₂—. In some embodiments, CₙF₂ₙ is branched, for example —CF₂—CF(CF₃)—. In some embodiments, (OCₙF₂ₙ)_{z} is a —O—(CF₂)₁₋₄—[O(CF₂)₁₋₄]₀₋₁ group. In some embodiments, Rf₂ is a linear or branched perfluoroalkyl comprising 1 to 8 (or 1 to 6) carbon atoms, optionally with up to 4, 3, or 2 intervening —O— groups. In some embodiments, Rf₂ is a perfluoroalkyl comprising 1 to 4 carbon atoms, optionally with one intervening —O— group. Suitable monomers of given formulae CF2═CFORf and CF₂═CF(OCnF₂ₙ)_{z}ORf₂ include perfluoromethylvinyl ether, perfluoroethylvinyl ether, perfluoropropylvinyl ether, CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkylvinyl ethers may be obtained using methods disclosed in U.S. Pat. No. 6,255,536 (Worm et al.) and U.S. Pat. No. 6,294,627 (Worm et al.).

Perfluoroalkylalkene ethers and perfluoroalkoxyalkylalkene ethers may also be used as comonomers to obtain the fluoropolymer of the invention. Furthermore, these fluoropolymers may include copolymerized monomer units of fluoro(alkene ethers), including monomers disclosed in U.S. Pat. No. 5,891,965 (Worm et al.) and U.S. Pat. No. 6,255,535 (Schulz et al.). Such monomers include compounds of formula CF₂═CF(CF₂)ₘ—O—R_{f}, where m is an integer from 1 to 4 and R_{f} is a linear or branched perfluoroalkylene which may comprise oxygen atoms, thus forming additional ether bonds, with R_{f} comprising 1 to 20, in some embodiments, 1 to 10 carbon atoms in the carbon backbone, with R_{f} optionally containing additional terminal unsaturation sites. In some embodiments, m is 1. Examples of suitable monomers of fluoro(alkene ethers) include perfluorinated ethers such as CF₂═CFCF₂—O—CF₃, CF₂═CFCF₂—O—CF₂—O—CF₃, CF₂═CFCF₂—O—CF₂CF₂—O—CF₃, CF₂═CFCF₂—O—CF₂CF₂—O—CF₂—O—CF₂CF₃, CF₂═CFCF₂—O—CF₂CF₂—O—CF₂CF₂CF₂—O—CF₃, CF₂═CFCF₂—O—CF₂CF₂—O—CF₂CF₂—O—CF₂—O—CF₃, CF₂═CFCF₂CF₂—O—CF₂CF₂CF₃. Suitable perfluoroalkoxyalkylallyl ethers include compounds of formula CF₂═CFCF₂(OCₙF₂ₙ)_{z}ORf₂, where n, z and Rf₂ are as defined above for perfluoroalkoxyalkylvinyl ethers. Examples of suitable perfluoroalkoxyalkylallyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇.

Many of the perfluoroalkoxyalkylallyl ethers may be obtained, e.g., using methods disclosed in U.S. Pat. No. 4,349,650 (Krespan).

The fluoropolymers may also comprise units obtained by copolymerization of at least one RaCF═CR^{a}₂ monomer with at least one non-fluorinated copolymerizable comonomer of formula R^{b}₂C═CR^{b}₂, where each R^{b} is independently hydrogen, chloro, an alkyl comprising 1 to 8, 1 to 4, or 1 to 3 carbon atoms, a cyclic saturated alkyl comprising 1 to 10, 1 to 8, or 1 to 4 carbon atoms, or an aryl comprising 5 to 8 carbon atoms. Examples of suitable monomers of formula R^{b}₂C═CR^{b}₂ include ethylene and propylene.

Perfluoro-1,3-dioxoles may also be used to obtain the amorphous fluoropolymer of the invention. Monomers of perfluoro-1,3-dioxoles and their copolymers are disclosed in U.S. Pat. No. 4,558,141 (Squires).

In some embodiments, the fluoropolymer is a copolymer of hexafluoropropylene and vinylidene fluoride. Such fluoropolymers are disclosed, e.g., in U.S. Pat. No. 3,051,677 (Rexford) and U.S. Pat. No. 3,318,854 (Honn, et al.). In some embodiments, at least one fluoropolymer is a copolymer of hexafluoropropylene, vinylidene fluoride and tetrafluoroethylene. Such fluoropolymers are disclosed, e.g., in U.S. Pat. No. 2,968,649 (Pailthorp et al.).

A preferred fluoropolymer usually comprises 30 to 90 percent by weight VDF and 70 to 10 percent by weight HFP (such as 30 to 50 wt % of HFP derived units and 70 wt % to 50 wt % of VDF derived units), and optionally comprises 0 to 50 wt %, or 0 to 30 wt %, preferably 0 to about 10 wt % of units derived from one or more additional co-monomers described above, provided the total amount of units is 100 wt %.

In some embodiments, the polymerized units derived from non-fluorinated olefin monomers are comprised in the fluoropolymer in an amount of up to 25 molar percent relative to the fluoropolymer, and in some embodiments, up to 10 molar percent or up to 3 molar percent. In some embodiments, the polymerized units derived from the at least one monomer of the perfluoroalkylvinyl ether or perfluoroalkoxyalkylvinyl ether are comprised in the fluoropolymer in an amount of up to 50 molar percent relative to the fluoropolymer, and in some embodiments, up to 30 molar percent or up to 10 molar percent.

The fluoropolymers described above may be obtained using methods known in the art. The fluoropolymers are usually obtained using aqueous emulsion polymerization followed by coagulation, washing, and drying. The polymerization reaction may be conducted to produce statistical copolymers or bimodal or multimodal polymers. The polymers may also be polymers of the core-shell type, block copolymers or heterogeneous polymers, e.g., having parts with a higher or lower comonomer content. Multimodal fluoropolymers are disclosed, e.g., in U.S. Pat. No. 6,277,919 (Dillon et al.).

If desired, e.g., to improve processing, the content of highly polar terminal groups, such as SO₃⁻ and COO⁻, may be decreased using known post-processing techniques (such as decarboxylation and subsequent fluorination). Chain transfer agents of any type can substantially decrease the number of ionic or polar terminal groups. Chain transfer agents and any long-chain branching modifiers, such as disclosed, e.g., in U.S. Pat. No. 7,375,157 (Amos et al.) and US patent application 2010/0311906 (Lavellee et al.), may be used to modify the architecture and/or weight of the polymers.

Thus, by varying initiator concentration and activity, concentration of each of the reacting monomers, temperature, concentration of the chain transfer agent, and solvent, the molecular weight of the amorphous fluoropolymer may be adjusted using methods known in the art. In some embodiments, fluoropolymers suitable for practicing the invention have a weight-average molecular weight in the range 10,000 g/mol to 200,000 g/mol. In some embodiments, the weight-average molecular weight is at least 15,000, 20,000, 25,000, 30,000, 40,000, or 50,000 g/mol, and is up to 100,000, 150,000, 160,000, 170,000, 180,000, or 190,000 g/mol. Fluoropolymers suitable for practicing the invention usually have a certain molecular weight distribution and composition. The weight-average molecular weight may be determined, e.g. with gel-permeation chromatography (i.e., exclusion chromatography) using methods known to a person of ordinary skill in the art.

Some fluoropolymers suitable as polymer processing additives are available commercially. As such, copolymers of hexafluoropropylene and vinylidene fluoride are commercially available from 3M Company, St. Paul, Minn.; E.I. duPont de Nemours and Co., Wilmington, Del.; Daikin Industries, Ltd., Osaka, Japan; and Arkema, Colombes, France. Fluoropolymers suitable for compositions of polymer processing additives may also include mixtures of several of the fluoropolymers described above.

Organosilicon Polymers

Organosilicon polymers suitable for compositions and methods of the invention include poly(diorganosiloxanes).

The poly(diorganosiloxanes) may have a molecular weight higher than 25,000 g/mol, higher than 50,000 g/mol, or higher than 100,000 g/mol, or from about 25,000 g/mol to less than about 200,000 g/mol or less than 150,000 g/mol. The poly(diorganosiloxanes) comprise repeat units of formula (—Si(R⁷)₂O—). The poly(diorganosiloxanes) are preferably linear. More preferably, the poly(diorganosiloxanes) are diorganosiloxane-polyamide block copolymers or diorganosiloxane-urethane block copolymers.

The poly(diorganosiloxane) may comprise a number of organic substituents at carbons that have bonds with silicon atoms in the siloxane. For example, each organic substituent may independently be alkyl, haloalkyl, arylalkylenyl, alkylarylenyl, alkenyl, aryl, or aryl substituted with alkyl, alkoxyl, or halogen. The poly(diorganosiloxane) may comprise the units of general formula (—Si(R⁷)₂O—), where R⁷ is as defined below for embodiments of R⁷ in Formula I. Examples of these include dimethylsilicones, diethylsilicones, and diphenylsilicones. In some embodiments, at least 40 percent, and in some embodiments, at least 50 percent, at least 60 percent, at least 70 percent, at least 80 percent, at least 90 percent, at least 95 percent, at least 98 percent, or at least 99 percent of R⁷ groups may be phenyl, methyl, or a combination thereof. In some embodiments, at least 50 percent, at least 50 percent, at least 60 percent, at least 70 percent, at least 80 percent, at least 90 percent, at least 95 percent, at least 98 percent, or at least 99 percent of R⁷ groups are methyl. A high molecular weight polydimethylsiloxane (PDMS) is commercially available, e.g., from Dow Corning Corporation, Midland, Mich.

Preferably, a polydimethylsiloxane polymer suitable for the PPA compositions of the invention comprises (—Si(R⁷)₂O—) repeat units and repeated amino groups, i.e., —(C═O)—N(R⁸)-G-N(R⁸)—(C═O)—. R⁷ and R⁸ are as described further below.

A linear polydiorganosiloxane-polyamide block copolymer suitable for practicing the invention comprises at least two repeat units of Formula I:

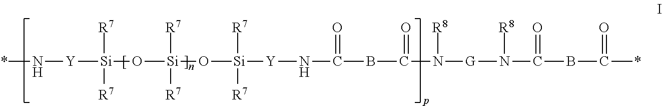

In this formula, each R⁷ is independently alkyl, haloalkyl, arylalkylenyl, alkylarylenyl, alkenyl, aryl, or aryl substituted with alkyl, alkoxyl, or halogen. Each Y is independently alkylene, arylalkylene, alkylarylene, or a combination thereof. Subscript n is independently 0 to 1,500 and subscript p is 1 to 10. Each B is independently a covalent bond, alkylene, arylalkylene, alkylarylene, or a combination thereof. When each B is a covalent bond, the polydiorganosiloxane-polyamide block copolymer of Formula I is referred to as polydiorganosiloxane-polyoxamide block copolymer. G is a divalent group, which is a residue corresponding to a diamine of formula R⁸HN-G-NHR⁸ with two —NHR⁸ groups removed. R⁸ is hydrogen or alkyl (e.g., an alkyl comprising 1 to 10, 1 to 6, or 1 to 4 carbon atoms), or R⁸ and G taken together with the nitrogen to which they are both connected to form a heterocyclic group. Each asterisk (*) indicates the connection site of the repeat unit to another group in the copolymer, such as, e.g., another repeat unit of Formula I.

Suitable alkyl groups for R⁷ in Formula I usually comprise 1 to 10, 1 to 6, or 1 to 4 carbon atoms. Examples of suitable alkyl groups include methyl, ethyl, isopropyl, n-propyl, n-butyl, and isobutyl. In suitable haloalkyl groups for R⁷, often only part of the hydrogens of the corresponding alkyl groups has been substituted for halogens. Examples of haloalkyl groups include chloroalkyl and fluoroalkyl groups comprising 1 to 3 halogen atoms and 3 to 10 hydrogen atoms. Suitable alkenyl groups for R⁷ often comprise 2 to 10 carbon atoms. Examples of the alkenyl groups often comprise 2 to 8, 2 to 6, or 2 to 4 carbon atoms, such as ethenyl, n-propenyl, and n-butenyl. Suitable aryl groups for R⁷ often comprise 6 to 12 carbon atoms. An example of the aryl group is phenyl. The aryl group may be unsubstituted or substituted with alkyl (i.e., it may be an alkylarenyl group) (e.g., the alkyl group may be an alkyl comprising 1 to 10 carbon atoms, 1 to 6 carbon atoms, or 1 to 4 carbon atoms), alkoxyl (e.g., with an alkoxyl comprising 1 to 10 carbon atoms, 1 to 6 carbon atoms, or 1 to 4 carbon atoms), or halogen (e.g., with chloro, bromo, or fluoro). Suitable arylalkylenyl and alkylarylenyl groups for R⁷ usually comprise an alkylene group comprising 1 to 10 carbon atoms and an aryl group comprising 6 to 12 carbon atoms. In certain arylalkylenyl and alkylarylenyl groups, the aryl group is phenyl and the alkylene group comprises 1 to 10 carbon atoms, 1 to 6 carbon atoms, or 1 to 4 carbon atoms. For example, R⁷ may be an arylalkylenyl group in which any of said alkylene groups is bonded to phenyl.

In some embodiments, in some of the repeat units of Formula I at least 40 percent, and in some embodiments at least 50 percent, of R⁷ groups are phenyl, methyl, or a combination thereof. For example, at least 60 percent, at least 70 percent, at least 80 percent, at least 90 percent, at least 95 percent, at least 98 percent, or at least 99 percent of R⁷ groups may be phenyl, methyl, or combinations thereof. In some embodiments, in some of the repeat units of Formula I at least 40 percent, and in some embodiments at least 50 percent, of R⁷ groups are methyl. For example, at least 60 percent, at least 70 percent, at least 80 percent, at least 90 percent, at least 95 percent, at least 98 percent, or at least 99 percent of R⁷ groups may be methyl. The remaining R⁷ groups may be selected from an alkyl comprising at least two carbon atoms, haloalkyl, arylalkylenyl, alkylarylenyl, alkenyl, aryl, or aryl substituted with alkyl, alkoxyl, or halogen.

Each Y in Formula I is independently alkylene, arylalkylene, alkylarylene, or a combination thereof. Suitable alkylene groups usually comprise up to 10 carbon atoms, up to 8 carbon atoms, up to 6 carbon atoms, or up to 4 carbon atoms. Examples of alkylene groups include methylene, ethylene, propylene, butylene, and similar groups. Suitable arylalkylene and alkylarylene groups usually comprise an arylene group comprising 6 to 12 carbon atoms bonded to an alkylene group comprising 1 to 10 carbon atoms. In certain arylalkylene and alkylarylene groups, the arylene moiety is phenylene. In other words, a divalent arylalkylene or alkylarylene group comprises phenylene bonded to alkylene comprising 1 to 10, 1 to 8, 1 to 6, or 1 to 4 carbon atoms. With reference to group Y, the term “combination thereof” refers to a combination of two or more groups selected from the alkylene, arylalkylene, or alkylarylene groups. Such a combination may be, e.g., one alkylarylene bonded to one alkylene (such as alkylene-arylene-alkylene). In one example of the combination alkylene-arylene-alkylene, the arylene is phenylene and each of the alkylenes comprises 1 to 10, 1 to 6, or 1 to 4 carbon atoms.

Each subscript n in Formula I is independently 0 to 1,500. For example, subscript n may be up to 1,000, up to 500, up to 400, up to 300, up to 200, up to 100, up to 80, up to 60, up to 40, up to 20, or up to 10. The value of n is often at least 1, at least 2, at least 3, at least 5, at least 10, at least 20, or at least 40. For example, subscript n may be 40 to 1,500, 0 to 1,000, 40 to 1,000, 0 to 500, 1 to 500, 40 to 500, 1 to 400, 1 to 300, 1 to 200, 1 to 100, 1 to 80, 1 to 40, or 1 to 20.

Subscript p is 1 to 10. For example, the value of p is often an integer up to 9, up to 8, up to 7, up to 6, up to 5, up to 4, up to, or up to 2. The value of p may be 1 to 8, 1 to 6, or 1 to 4.

G in Formula I is a divalent group, which is a residue corresponding to a diamine of formula R⁸HN-G-NHR⁸ with two amino groups (i.e., —NHR⁸ groups) removed. The diamine may comprise primary or secondary amino groups. R⁸ is hydrogen or alkyl (e.g., an alkyl comprising 1 to 10, 1 to 6, or 1 to 4 carbon atoms), or R⁸ and G taken together with the nitrogen to which they are both connected to form a heterocyclic group (such as a 5-7-member ring). In some embodiments, R⁸HN-G-NHR⁸ is piperazine. In some embodiments, R⁸ is hydrogen or alkyl. In some embodiments, both amino groups in the diamine are primary amino groups (i.e., both R⁸ groups are hydrogen), and the diamine has the formula H₂N-G-NH₂.

In some embodiments, G is alkylene, heteroalkylene, polyorganosiloxane, arylene, arylalkylene, alkylarylene, or a combination thereof. Suitable alkylenes often comprise 2 to 10, 2 to 6, or 2 to 4 carbon atoms. Examples of alkylene groups include ethylene, propylene, and butylene. Suitable heteroalkylenes are often polyoxyalkylenes, such as polyoxyethylene comprising at least 2 ethylene units, polyoxypropylene comprising at least 2 propylene units, or their copolymers. Examples of polydiorganosiloxanes include alkylene-capped polydimethylsiloxanes. Suitable arylalkylene groups usually comprise an arylene group comprising 6 to 12 carbon atoms bonded to an alkylene group comprising 1 to 10 carbon atoms. Some examples of arylalkylene groups are phenylene-alkylenes, in which phenylene is bonded to an alkylene comprising 1 to 10 carbon atoms, 1 to 8 carbon atoms, 1 to 6 carbon atoms, or 1 to 4 carbon atoms. Some examples of alkylarylene groups are alkylene-phenylenes, in which an alkylene comprising 1 to 10 carbon atoms, 1 to 8 carbon atoms, 1 to 6 carbon atoms, or 1 to 4 carbon atoms is bonded to phenylene. With reference to group G, the term “combination thereof” refers to a combination of two or more groups selected from alkylene, heteroalkylene, polyorganosiloxane, arylene, arylalkylene, and alkylarylene. Such a combination may be, e.g., one alkylarylene bonded to one alkylene (such as alkylene-arylene-alkylene). In one example of the combination alkylene-arylene-alkylene, the arylene is phenylene and each of the alkylenes comprises 1 to 10, 1 to 6, or 1 to 4 carbon atoms.

In some embodiments, the polydiorganosiloxane-polyamide is a polydiorganosiloxane-polyoxamide. The polydiorganosiloxane-polyoxamide usually does not comprise groups of formula —B—(CO)—NH—, where B is alkylene. All carbonylamino groups in the backbone of a copolymer material are usually a part of oxalylamino group (i.e., —(CO)—(CO)—NH—), and B is a covalent bond. In other words, any carbonyl group in the backbone of a copolymer material is bonded to another carbonyl group and forms part of an oxalyl group. In particular, the polydiorganosiloxane-polyoxamide comprises a multitude of aminooxalylamino groups.

The polydiorganosiloxane-polyoxamide is a block copolymer and may be an elastomeric material. In contrast to many known polydiorganosiloxane-polyoxamides, which are usually obtained as brittle solids or hard plastics, the polydiorganosiloxane-polyoxamides of the invention may comprise more than 50 weight percent of polydiorganosiloxane fragments relative to the weight of the copolymer. The weight fraction of polydiorganosiloxane in the polydiorganosiloxane-polyoxamide can be increased by using polydiorganosiloxane segments with a higher molecular weight to provide more than 60 weight percent, more than 70 weight percent, more than 80 weight percent, more than 90 weight percent, more than 95 weight percent, or more than 98 weight percent of polydiorganosiloxane segments in the polydiorganosiloxane-polyoxamides. Higher amounts of polydiorganosiloxane may be used to obtain elastomeric materials with a lower modulus while retaining a reasonable strength.

Silicone-polyurethane copolymers (SPC) suitable as the polymer processing additives in the compositions and methods of the invention include block copolymers comprising an organosilicon block and second blocks derived from a multifunctional isocyanate. As used herein, the term “silicone-polyurea” may be used interchangeably with the term “silicone-polyurethane”. The blocks derived from an isocyanate may comprise two functional groups (such as —NHCONH— or —NHC(O)O—) bonded to a divalent organic radical (such as alkyl, cycloalkyl and aryl groups comprising 1 to 30 carbon atoms). Examples of suitable diisocyanate compounds from which the second blocks can be derived include ethylenediisocyanate, 1,6-hexylenediisocyanate, 1,12-dodecylenediisocyanate, 4,4′-diphenylmethanediisocyanate, 3,3′-dimethoxy-4,4′-diphenylmethanediisocyanate, 3,3′-dimethyl-4,4′-diphenylmethanediisocyanate, 4,4′-diphenyldiisocyanate, toluene-2,6-diisocyanate, mixtures of toluene-2,6-diisocyanate and toluene-2,4-diisocyanate, 1,4-cyclohexylenediisocyanate, 4,4′-dicyclohexylmethanediisocyanate, 3,3′-diphenyl-4,4′-biphenylenediisocyanate, 4,4′-biphenylenediisocyanate, 2,4-diisocyanate diphenyl ether, 2,4-dimethyl-1,3-phenylenediisocyanate, 4,4′-(diphenyl ether)diisocyanate, isophoronediisocyanate, and mixtures thereof.

The organosilicon blocks include the blocks of general formula (Si(R⁷)₂O—), where R⁷ is as defined above for R⁷ in Formula I. Non-limiting examples include dimethylsilicones, diethylsilicones, and diphenylsilicones.

Copolymers comprising polydioranosiloxane-urethane (a subclass of the SPC class of materials) suitable for the compositions of the invention comprise flexible polydioranosiloxane units, rigid units of polyisocyanate residues, terminal groups, and optionally flexible and/or rigid units of organic polyamine residues. Certain copolymers comprising polydioranosiloxane-urea are commercially available under the trademark “GENIOMER 140” from Wacker Chemie AG, Germany. The polyisocyanate residues are a polyisocyanate with removed —NCO groups, the organic polyamine residues are an organic polyamine with removed —NH groups, and the polyisocyanate residue is connected to the polydioranosiloxane units or organic polyamine residues via urethane bonds. The terminal groups may be non-functional groups or functional groups, depending on the intended application of the copolymer comprising the polydioranosiloxane-urea.

In some embodiments, the copolymers comprising polydioranosiloxane-urethane and suitable as the polymer processing additives comprise at least two repeat units of Formula II

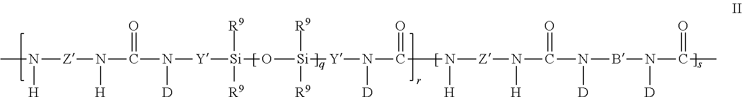

In Formula II, each R⁹ is a fragment which is independently alkyl, cycloalkyl, aryl, perfluoroalkyl, or perfluoroether. In some embodiments of R⁹, the alkyl comprises 1 to 12 carbon atoms and may be further substituted, e.g., with trifluoroalkyl, vinyl, vinyl radical, or a higher alkenyl of formula —R¹⁰(CH₂)ₐCH═CH₂, where R¹⁰ is —(CH₂)_{b}— or —(CH₂)_{c}CH═CH— and a is 1, 2, or 3; b is 0, 3, or 6; and c is 3, 4, or 5. In some embodiments of R⁹, the cycloalkyl comprises about 6 to 12 carbon atoms and may be further substituted with one or more alkyl, fluoroalkyl, or vinyl. In some embodiments of R⁹, the aryl comprises about 6 to 20 carbon atoms and may be further substituted, e.g., with alkyl, cycloalkyl, fluoroalkyl, and vinyl. In some embodiments of R⁹, the perfluoroalkyl is as disclosed in U.S. Pat. No. 5,028,679, the disclosure of which is incorporated herein by reference, and the group comprising a perfluoroether is as disclosed in U.S. Pat. Nos. 4,900,474 and 5,118,775, the disclosures of which are incorporated herein by reference. In some embodiments, R⁹ is a group comprising fluoro as disclosed in U.S. Pat. No. 5,236,997, the disclosure of which is incorporated herein by reference. In some embodiments, at least 50% of R⁹ fragments are methyl radicals, while the remaining fragments are monovalent alkyl or substituted alkyl radicals comprising 1 to 12 carbon atoms, alkenylene radicals, phenyl radicals, or substituted phenyl radicals. In Formula II, each Z′ is arylene, arylalkylene, alkylene, or cycloalkylene. In some embodiments of Z′, the arylene or arylalkylene comprises about 6 to 20 carbon atoms. In some embodiments of Z′, the alkylene or cycloalkylene radical comprises about 6 to 20 carbon atoms. In some embodiments, Z′ is 2,6-toluylene, 4,4′-methylenediphenylene, 3,3′-dimethoxy-4,4′-biphenylene, tetramethyl-meta-xylylene, 4,4′-methylenedicyclohexylene, 3,5,5-trimethyl-3-methylenedicyclohexylene, 1,6-hexamethylene, 1,4-cyclohexylene, 2,2,4-trimethylhexylene, or mixtures thereof. In Formula II, each Y′ is independently alkylene, arylalkylene, alkylarylene, or arylene. In some embodiments of Y′, the alkylene comprises 1 to 10 carbon atoms. In some embodiments of Y′, the arylalkylene, alkylarylene, or arylene comprises 6 to 20 carbon atoms. In Formula II, each D is independently a hydrogen atom, an alkyl radical comprising 1 to 10 carbon atoms, phenyl, or a radical complementing the ring structure comprising B′ or Y′ to form a heterocycle. In Formula II, B is a polyvalent radical selected from the group consisting of alkylene, arylalkylene, alkylarylene, cycloalkylene, phenylene, and polyalkyleneoxide (such as polyethyleneoxide, polypropyleneoxide, polytetramethyleneoxide, and copolymers and mixtures thereof). In Formula II, s is a number between 0 and about 1,000; r is a number equal to or larger than 1; and q is a number of about 5 or larger, in some embodiments about 15 to 2,000, and in some embodiments about 30 to 1,500.

When using polyisocyanates (Z′ is a radical with functionality higher than 2) and polyamines (B′ is a radical with functionality higher than 2), the structure of Formula II will be modified to reflect the branching of the polymer backbone. When using terminal group blocking agents, the structure of Formula II will be modified to reflect the terminal groups of the polydiorganoliloxane-urea chain.

Block copolymers comprising the units of Formula I and polymers comprising the polydiorganoliloxane-urea of Formula II may be obtained, e.g., as disclosed in US patent application 2011-0244159 (Papp et al.).

The compositions of the polymer processing additives can be selected so as to be applicable for melt processing (such as melt extrusion) at the chosen extrusion temperature. Melt processing is usually performed at temperatures between 180° C. to 280° C., although optimal processing temperatures are chosen depending upon the melting point, melt viscosity, and thermal stability of the composition, and upon the type of equipment employed for melt processing.

The compositions of the polymer processing additives of the invention comprising an organosilicon polymer and a fluoropolymer may be applied in the form of powder, pellets, or beads with the desired particle size (with particles either already being of a size from about 0.5 to about 20 or being ground to the indicated size) or particle size distribution (with number average particle size from about 0.5 to about 20 or ground to the indicated average size), or in any other form suitable for extrusion.

The compositions of the polymer processing additives may comprise the fluoropolymer and the organosilicon polymer in a weight ratio of about 1:50 to 50:1, preferably about 1:10 to 10:1, and more preferably about 1:5 to 3:1. When more than one fluoropolymer and/or organosilicon polymer is present, the weight ratio is the ratio of the total amount of fluoropolymer to the total amount of organosilicon polymer.

Excipients

The compositions of the polymer processing additives of the invention may optionally comprise traditional excipients such as antioxidants, hindered amine light stabilizers (HALS), UV-stabilizers, metal oxides (such as magnesium oxide and zinc oxide), antiblocking agents (such as coating or non-coating), and pigments and fillers (such as titania, carbon black and silica).

HALS are usually free radical-scavenging compounds that may be formed through oxidative decomposition. Some suitable HALS comprise a tetramethylpiperidine moiety in which the piperidine nitrogens may be either unsubstituted or substituted with alkyl or acyl. Examples of suitable HALS include bis-(2,2,6,6-tetramethyl-1-(octyloxy)-4-piperidinyl)decanedioic acid ester, bis-(2,2,6,6-tetramethyl-4-piperidyl)-sebacinate, 8-acetyl-3-dodecyl-7,7,9,9-tetramethyl-1,3,8-triazaspiro-(4,5)-decan-2,5-dione, bis-(2,2,6,6-tetramethyl-4-hydroxypiperidyl-succinate), and bis-(N-methyl-2,2,6,6-tetramethyl-4-piperidyl)-sebacinate. Suitable HALS further include, e.g., compounds available from BASF, Florham Park, N.J., under the trademark “CHIMASSORB”. Examples of antioxidants include compounds available under the trademarks “IRGAFOS 168”, “IRGANOX 1010”, and “ULTRANOX 626”, as well as from BASF. These stabilizers, if present, may be included in the compositions of the invention in any effective amount, usually at up to 5, 2, 1 weight percent of the total weight of the polymer processing additive composition, and usually in the amount of at least 0.1, 0.2, or 0.3 weight percent.

Other excipients include property enhancing compounds, also known as “synergists” or “surfactants”. The best-known surfactants include poly(oxyalkylenes). Polyoxyalkylenes may be introduced and selected based on their properties as surfactants in the mixtures of polymer processing additives. A polyoxyalkylene may be selected so that it (1) is in a liquid (or molten) state at the chosen extrusion temperature; (2) has a lower melt viscosity than the base polymer and the polymer processing additive; and (3) wets the surface of the particles of the polymer processing additive in the extruded compositions. Suitable polyoxyalkylene include, but are not limited to, polyethyleneglycols (PEG). PEG may be represented by formula H(OC₂H₄)ₓOH, where x′ is about 15 to 3,000. Many of the polyethyleneglycols indicated, as well as their ethers and esters, are commercially available from multiple sources. Ethers and esters of the PEG indicated may also be suitable.

Aliphatic polyesters, such as poly(butyleneadipinate), polylactic acid and polycaprolactone polyesters (in particular, with a number average molecular weight in the range of 1,000 to 32,000, preferably 2,000 to 10,000, and most preferably 2,000 to 4,000), and aromatic polyesters, such as poly(diisobutylphthalate), may also be suitable surfactants.

Other excipients include, e.g., aminoxides such as octyldimethylaminoxide, carboxylic acids such as hydroxybutanebioic acid, fatty acid esters such as sorbitan monolaurate, and triglycerides.

Mixtures of two or more different polyoxyalkylenes, or polyoxyalkylene mixtures with other types of surfactants, such as the abovementioned esters, may also be used.

Polyoxyalkylene thermal stability may be improved with a metal salt of a carboxylic acid, sulfonic acid, or alkylsulfate, as disclosed, e.g., in international patent application WO 2015/042 415.

A suitable polymer processing additive composition comprising a fluoropolymer and an organosilicon polymer may comprise about 5 to 95 weight percent of a surfactant and 95 to 5 weight percent of the fluoropolymer or organosilicon polymer. In some embodiments, the polymer processing additive composition comprises at least about 25, 40, or 50 weight percent of the surfactant relative to the total amount of the polymer processing additive composition. In some embodiments, the polymer processing additive composition comprises at least about 0.125, 0.2, or 0.25 weight percent of the metal salt of a carboxylic acid, sulfonic acid, or alkylsulfate relative to the total amount of the polymer processing additive composition. The usual ratio of the fluoropolymer or the organosilicon polymer to the polyoxyalkylene component (including the metal salt of a carboxylic acid, sulfonic acid, or alkylsulfate) in the polymer processing additive composition is 1/2 to 2/1.

Base Polymers

The PPA compositions of the invention may be applied to improve melt processing of base polymers, for example, to process a base polymer at a shear rate of 500 sec⁻¹, e.g., for pelletizing or compounding by melt extrusion. Therefore, the compositions of the invention may additionally comprise a base polymer. In general, the base polymer is a thermoplastic extruded non-fluorinated polymer. The non-fluorinated polymer may comprise no fluorine atoms. It is generally believed that a wide range of thermoplastic polymers are applicable. Examples of suitable thermoplastic polymers include non-fluorinated polymers such as hydrocarbon resins, polyamides (such as nylon 6, nylon 6/6, nylon 6/10, nylon 11, and nylon 12), polyesters (such as polyethyleneterephthalate, polybutyleneterephthalate, and polylactic acid), chloropolyethylene, polyvinyl resins (such as polyvinylchloride, polyacrylates, and polymethacrylates), polycarbonates, polyketones, polyureas, polyimides, polyurethanes, polyolefines, and polystyrenes. Preferably, the extruded thermoplastic polymer is polyolefin.

Suitable extruded polymers have melt flow indices (determined according to ASTM D1238 at 190° C. using a 2,160 gram weight) of 4.0 grams per 10 minutes or less, preferably 3.0 grams per 10 minutes or less, or, e.g., between 0.01 gram per 10 minutes and 0.8 gram per 10 minutes.

In general, the base polymer has a melt flow index of at least 0.001 gram per 10 minutes.

Polyolefins suitable for practicing the invention may be obtained through homopolymerization or copolymerization of olefins. Preferably, the polyolefin is a polypropylene homopolymer or a propene copolymer with one or more comonomers. A typical polypropylene copolymer may comprise more than 50 wt % (relative to the total weight of the copolymer 100 wt %) of units derived from propene (propylene). Suitable polypropylene copolymers may comprise up to about 30 weight percent, or in some embodiments, 20 weight percent or less, of one or more monomers that are copolymerizable with propene. Examples of monomers that are copolymerizable with propene include: olefins of general structure CH₂═CHR³, where R³ is hydrogen or alkyl. In some embodiments, the alkyl radical comprises up to 10 carbon atoms, or 1 to 6 carbon atoms. The copolymerizable olefins include ethylene, 1-butene, 3-methylbutene, 4-methylpentene, 1-hexene, 1-octene, 1-decene, 4-methyl-1-pentene, and 1-octadecene. Other examples of copolymerizable monomers include vinyl-ester monomers such as vinylacetate, vinylbutyrate, vinylchloroacetate, and vinylchloropropionate; monomers of acrylic acid and alpha-alkylacrylic acids and the corresponding alkyl esters, amides, and nitriles, such as acrylic acid, methacrylic acid, ethacrylic acid, methylacrylate, ethylacrylate, N,N-dimethylacrylamide, methacrylamide, and acrylonitrile; vinylaryl monomers such as styrene, ortho-methoxystyrene, para-methoxystyrene, and vinylnaphthalene; monomers of vinyl- and vinylidenehalogenides, such as vinylchloride, vinylidenechloride and vinylidenebromide; alkylester monomers of maleic and fumaric acids and corresponding anhydrides, such as dimethylmaleate, diethylmaleate, and maleinic anhydride; monomers of vinylalkyl ethers such as vinylmethyl ether, vinylethyl ether, vinylisobutyl ether, and 2-chloroethylvinyl ether; monomers of vinylpyridine; monomers of N-vinylcarbazole; and monomers of N-vinylpyrrolidone.

In some embodiments, the polyolefin suitable for the compositions and methods of the invention is obtained via Ziegler-Natta catalysis. In some embodiments, the polyolefin suitable for the compositions and methods of the invention is obtained via homogenous catalysis. In some embodiments, homogeneous catalysis refers to catalysis in which the catalyst and substrate are in the same phase (such as in solution). In some embodiments, homogeneous catalysis refers to catalysis performed at catalysts having a single active site. Single-site catalysts usually comprise a single metal center.

In some embodiments, the polyolefin obtained via homogeneous catalysis is a polyolefin obtained at a metallocene catalyst. Homogeneous and single-site catalysts other than metallocenes are also suitable for affording polyolefins obtained by homogeneous catalysis. The polyolefins obtained by homogeneous catalysis may have higher molecular weights, lower polydispersities, lower contents of extractables, and a different stereochemistry in comparison to polyolefins obtained using different methods such as via Ziegler-Natta catalysis. Homogeneous catalysis also allows a wider selection of polymerizable monomers in comparison to Ziegler-Natta catalysis. In Ziegler-Natta catalysis that uses complexes of halogenated transition metals together with organometallic compounds, the polyolefin resin produced may contain acidic residues. Additives to neutralize the acid, such as calcium stearate and zinc stearate, have been added to such resins. In polyolefins produced via homogeneous catalysis, such acidic residues are usually not present; therefore, acid-neutralizing additives may not be required.

The compositions comprising the non-fluorinated thermoplastic polymers suitable for practicing any embodiments of the invention may comprise any traditional excipients as described above in any variants of their embodiment, such as antioxidants, hindered amine light stabilizers (HALS), UV-stabilizers, metal oxides (such as magnesium oxide and zinc oxide), antiblocking agents (such as coating or non-coating), and pigments and fillers (such as titania, carbon black and silica).

The non-fluorinated thermoplastic polymers may be applied in the form of powder, pellets, beads, or in any other form suitable for extrusion.

Concentrates and Extruded Composition

The extruded compositions of the invention may be obtained via any of a number of ways. For example, a mixture of a fluoropolymer and an organosilicon polymer may be mixed with a non-fluorinated thermoplastic polymer during extrusion to obtain polymer products.

The compositions of the invention may also include so-called concentrates, which may comprise a mixture of a fluoropolymer and an organosilicon polymer, other components (such as a synergist or an excipient as described above), and/or one or more base thermoplastic polymers. The concentrate may be a convenient diluted form of the polymer processing additive. The concentrates may comprise at least one fluoropolymer and at least one organosilicon polymer, as described above, and may optionally comprise a synergist dispersed or mixed with a base polymer, as described above. Preparation of the concentrate may allow for a more precise introduction of the predetermined amounts of the polymer processing additives into the extruded composition. The concentrate may be a composition ready to be introduced into the thermoplastic polymer for extrusion to obtain the polymer product. The concentrates comprising the concentrations of the polymer processing additives quoted below are often obtained at relatively high temperatures under aerobic conditions.

The concentrates may also be obtained by mixing a fluoropolymer and an organosilicon polymer with other components included in the formulation, then forming the mixture into pressed pellets using a method that corresponds to or is close to the method disclosed in US patent application 2010/0298487 (Bonnet et al.).

The non-fluorinated thermoplastic base polymer for extrusion and the polymer processing additive composition may be combined using any mixing means commonly applied in the polymer industry, such as a compounding mill, a Banbury mill or a compounding extruder, in which the polymer processing additive composition is evenly distributed over the bulk of the base thermoplastic polymer. The mixing operation is most conveniently performed at a temperature above the softening point of the fluoropolymer, although the components may be mixed dry as dispersed materials and the homogeneous distribution of the components may then be obtained by feeding the dry mix into a twin-screw melting extruder.

The mixture obtained may be pelletized or otherwise ground to obtain the desired particle size or particle size distribution and then fed to an extruder, which will usually be a single-screw extruder, in which the obtained mixture undergoes further melt processing. The melt processing is usually performed at a temperature between 180° C. and 280° C., although optimal processing temperatures are chosen depending upon the melting point, melt viscosity, and thermal stability of the processed mixture. The compositions of the invention may be extruded using various types of extruders. The extruder die configuration may vary depending on the target extrudate. For example, an annular die may be used to extrude a tube suitable for making a fuel hose, as disclosed in U.S. Pat. No. 5,284,184 (Noone et al.).

The compositions of the invention may be mixed with another non-fluorinated thermoplastic polymer and/or other components to obtain a composition ready to be processed into a polymer product. In other cases, the composition may comprise all the required ingredients and be ready for extrusion into a polymer product. The amount of fluoropolymer and organosilicon polymer in such compositions is usually relatively low. Therefore, some embodiments of the composition of the invention contain a large amount of the non-fluorinated thermoplastic base polymer. This large amount is to be understood as more than 50 weight percent, or at least 50 weight percent of the total weight of the composition. In some embodiments, the large amount is at least 60, 70, 75, 80, or 85 weight percent of the total weight of the composition. The actual amount may vary depending on whether the extruded composition is being extruded into its final form (such as film), or is being applied as the concentrate or processing additive that is to be (additionally) diluted with an additional base polymer prior to being extruded into its final form.

In general, the composition of the invention comprising a non-fluorinated thermoplastic polymer comprises fluoropolymers and organosilicon polymers of the invention by weight in the range of about 0.002 to 50 weight percent (in some embodiments 0.002 to 10 weight percent) relative to the total weight of the composition. In the concentrate composition, the amount of the fluoropolymers and organosilicon polymers of the invention, as well as of any synergist of the polymer processing additive, if present, may be between 1 percent and 50 percent, in some embodiments 1 percent to 10 percent, 1 percent to 5 percent, 2 percent to 10 percent, or 2 percent to 5 percent, relative to the total weight of the composition. When the composition is being extruded into its final form and is not further diluted by adding a base polymer, is usually comprises a lower concentration of the fluoropolymer and organosilicon polymer. In certain of the embodiments described, the combined amount of the fluoropolymers and organosilicon polymers of the invention, together with any synergist of the polymer processing additive, if present, is about 0.002 to 2 weight percent, in some embodiments about 0.01 to 1 weight percent or 0.01 to 0.2 weight percent, relative to the total weight of the composition. The upper concentration limit of the polymer processing additive composition employed is, in general, determined by economic considerations rather than by any detrimental physical impacts of a high concentration of the polymer processing additive.

The compositions of the invention may be extruded or processed in various ways, including, e.g., film extrusion, extrusion blowing, injection molding, extrusion of pipes, wires and cables, and fiber production.

The foregoing disclosure may be understood more fully by studying the examples given further below. It is to be understood that these examples are provided by way of illustration only and are not intended as a limitation of the invention in any way.

### EXAMPLES

Unless otherwise stated, all parts, fractions, ratios, etc. in the examples and in the disclosure as a whole are given by weight.

### Example 1

A concentrate composition was prepared comprising 1,800 ppm, 600 ppm, and 300 ppm of the polymer processing additive compositions (PPA-1 to PPA-3) in the base resin (polypropylene resin available under the trademark SIBUR PPR 003EX/1, MFI 0.3 g/10 min, from SIBEX, Russia) in a hot rotary mixer from Brabender Plasti-Corder by combining pellet-polypropylene (average size 3-5 mm) with PPA compositions (particle size 0.1-0.5 mm) to obtain three concentrate compositions (1-5 mm flakes) at 180° C., 80 rpm for 8 min. PPA-1 comprised a fluoropolymer processing additive (a VDF-HPF copolymer with a Mooney viscosity of 40-60; ASTM D 1646-06 Part A). PPA-2 comprised an organosilicon processing additive (a polidiorganosiloxane-amide block copolymer prepared according to US patent application 2011-0244159 (Papp et al.)). PPA-3 comprised a mixture of PPA-1 and PPA-2 with weight ratio 1:1, i.e., 300 ppm of the PPA-3 concentrate comprised 150 ppm PPA-1 and 150 ppm PPA-2.

Extrusion experiments were performed on a single-screw extruder to investigate rheological properties BRABENDER Lab Station. Screw rotation rate was 30 rpm, and shear rate amounted to about 2,700 sec⁻¹. The following temperature profile was employed: T1=240° C., T2=250° C., T3=270° C., T4=280° C., T5 (die=270°) C. The pretreatment method was chosen in order to obtain a fast coating.

The polypropylene resin (Sibex PPR 003EX/1, MFI 0.3 g/10 min) was extruded under the indicated conditions, measuring extrusion pressure (pressure drop in a round capillary die with geometry 30 (length)×1 (diameter) mm). In separate experiments, the polymer processing additives PPA-1 to PPA-3 were introduced into neat PP, measuring the extrusion pressure versus time. The PPA compositions were introduced in the amounts of 1,800 ppm with reduction down to 300 ppm: a PPA concentration of 1,800 ppm was maintained for about 30 minutes, followed by a PPA concentration of 600 ppm for the next 30 minutes, and finally by PPA concentration of 300 ppm for thirty minutes.

After each run, the extruder was cleaned using an antisticking concentrate to obtain the same pressure drop as for the neat material.

The pressure drop due to introduction of the polymer processing additive compositions (PPA-1, PPA-2 and PPA-3) upon extrusion of polypropylene was noted. The pressure as measured for PPA-1 at 1,800 ppm concentration was 238 to 243 bar. At 600 ppm concentration, the pressure was 238 to 235 bar, and at 300 ppm concentration, the pressure was 236 to 238 bar.

The pressure as measured for PPA-2 at 1,800 ppm concentration was 247 to 234 bar. At 600 ppm concentration, the pressure was 234 to 237 bar, and at 300 ppm concentration, the pressure was 239 to 238 bar.

The pressure as measured for PPA-3 at 1,800 ppm concentration was 247 to 233 bar. At 600 ppm concentration, the pressure was 233 to 232 bar, and at 300 ppm concentration, the pressure was 233 to 236 bar.

The results demonstrated that the reduction of pressure was at maximum when using the polymer processing additive composition comprising a combination of a fluoropolymer and an organosilicon polymer. The effect was synergistic, i.e., the effect for the combination of ingredients was greater than for individual ingredients.

### Example 2

Example 1 was repeated, this time using the polymer processing additive compositions PPA-3a and PPA-3b instead of PPA-3. PPA-3a and PPA-3b were mixtures of PPA-1 and PPA-2 with different weight ratios. PPA-3a comprised PPA-1 and PPA-2 in a weight ratio of 1:3. PPA-3b comprised PPA-1 and PPA-2 in a weight ratio of 3:1. Extrusion experiments with both PPA-3a and PPA-3b demonstrated a larger reduction of pressure than in experiments with PPA-1 and PPA-2. The pressure drop for PPA-3a and PPA-3b was lower than the pressure drop observed for PPA-1 in Example 1. The pressure drop for PPA-3a was larger than for PPA-3b.

### Comparative Example 1

Example 1 was repeated using a crystalline TFE-HFP-VDF copolymer instead of an elastomeric VDF-HPF copolymer. No enhanced pressure reduction was observed for a combination of said polymer with an organosilicon polymer.

Those skilled in the art will appreciate that numerous changes and modifications to the foregoing disclosure can be made without departing from the spirit and scope of the invention, and it is to be understood that the invention is not intended to be limited in any way by the illustrative embodiments provided herein.

1. A polymer processing additive (PPA) composition to improve melt extrusion of an extruded composition comprising an extruded thermoplastic polymer, the PPA composition comprising at least one fluoropolymer having a Mooney viscosity (ML 1+10 @ 121° C.) of 30 to 90 (Mooney Viscosity Procedure), and at least one polydiorganosiloxane polymer, wherein said extruded thermoplastic polymer is selected from a polypropylene homopolymer, a polypropylene copolymer, and a combination thereof.

2. The polymer processing additive composition of claim 1, wherein said fluoropolymer is a copolymer of HFP and VDF, optionally comprising up to 49 weight percent (relative to the total weight of the fluoropolymer, constituting 100 weight percent) of units derived from one or more additional comonomers.

3. The polymer processing additive composition of claim 1, wherein said fluoropolymer has a Mooney viscosity (ML 1+10 @ 121° C.) of 40 to 70 (Mooney Viscosity Procedure).

4. The polymer processing additive composition of claim 1, wherein the weight ratio of the fluoropolymer to the polydiorganosiloxane polymer is 1:50 to 50:1.

5. The polymer processing additive composition of claim 4, wherein the weight ratio of the fluoropolymer to the polydiorganosiloxane polymer is 1:10 to 10:1.

6. The polymer processing additive composition of claim 1, wherein said polydiorganosiloxane polymer comprises repeated —Si(R⁷)₂—O— groups, where each R⁷ is independently an alkyl, haloalkyl, arylalkylenyl, alkylarylenyl, alkenyl, aryl, or aryl substituted with alkyl, alkoxyl, or halogen.

7. The polymer processing additive composition of claim 6, wherein said polydiorganosiloxane polymer further comprises at least one amide and/or polyurethane group.

8. The polymer processing additive composition of claim 1, further comprising one or more synergists selected from group consisting of polyoxyalkylene polymers, aliphatic polyesters, polylactic acid and polycaprolactone polyesters, and aromatic polyesters.

9. The polymer processing additive composition of claim 1, wherein said extruded thermoplastic polymer has a melt flow index (MFI) of less than 1.0 g/10 min (determined according to ASTM D1238 at 190° C. using a 2,160 gram weight).

10. The polymer processing additive composition of claim 1, wherein
said extruded thermoplastic polymer is a polypropylene comonomer comprising more than 50 weight percent (relative to the total weight of the copolymer, constituting 100 weight percent) of units derived from propene (propylene).

11. An extruded composition comprising about 0.002 to 50 weight percent (relative to the total weight of the composition, constituting 100 weight percent) of the polymer processing additive composition of claim 1 and at least 50 weight percent (relative to the total weight of the composition, constituting 100 weight percent) of an extruded thermoplastic polymer selected from polypropylene homopolymers, polypropylene copolymers, and combinations thereof.

12. The extruded composition of claim 11, wherein said extruded thermoplastic polymer has a melt flow index (MFI) (determined according to ASTM D1238 at 190° C. using a 2,160 gram weight) of 0.01 to 0.8 gram per 10 minutes.

13. An extruded product comprising the composition of claim 11.

14. The extruded product of claim 13, selected from films, pellets, hoses, and pipes.

15. A method for making a melt extruded product, the method comprising extrusion of an extruded composition comprising an extruded thermoplastic polymer and further comprising a polymer processing additive composition of claim 1, wherein said extruded thermoplastic polymer is selected from polypropylene homopolymers, polypropylene copolymers, and combinations thereof.

16. The method of claim 15, wherein said extruded thermoplastic polymer has a melt flow index (MFI) of less than 4.0 g/10 min and more than 0.001 g/10 min (determined according to ASTM D1238 at 190° C. using a 2,160 gram weight).
